(19) United States
(12) Patent Application Publication
(10) Pub. No.: US 2007/0015673 A1
(43) Pub. Date: Jan. 18, 2007

(54) Soda nozzle cleaner

(76) Inventors: Joel Davis, Houston, TX (US); Dan McGrew Quinn, College Station, TX (US)

Correspondence Address: DAN QUINN, 2506 Raintree Drive, College Station, TX, 77845, US

(21) Appl. No.: 11/180,274

(22) Filed: Jul. 14, 2005

(51) Int. Cl. C11D 3/02

(52) U.S. Cl. 510/218

(57) ABSTRACT

The present invention Soda Nozzle Cleaner provides a detergent capable of removing sugar and soil build up on nozzles and diffusers found on fountain machine that disperse soft drinks. The Soda Nozzle Cleaner comprises: (a) granules formed from a mixture of citric acid powder, sodium carbonate, potassium peroxymonosulfate, and sodium perborate monohydrate these particle size range from about 100 microns to about 1200 microns; (b) the Soda Nozzle Cleaner product being adapted to readily dissolve and disperse the granules into one quart of water and soda nozzles and diffusers are soaked approximately eight to ten hours, then rinsed with water, and placed back into service on fountain machine.

This product was designed to clean nozzles and diffusers that are part of a soda soft-drink dispenser. It is a powder composed of 20% Citric Acid, 11% Sodium Carbonate, 4.3% Pottassium Peroxymonosulfate, 10% Sodium Perborate Monohydrate, and 54.7% non-Hazardous Ingredients (see attached Material Safety Information).

### SUMMARY

This product is the first of its kind to clean soda nozzles and diffusers that are part of a soda-soft drink dispenser. The powder removes sugar and soiled build up on the nozzles and diffusers without adverse effect to the rubber rings that are part of the nozzles. By adding the powder to water, then soaking the nozzles and diffusers in the substance overnight the product is able to perform the above task.

### DETAILED DESCRIPTION OF THE INVENTION

To date there is no standard procedure for cleaning soda nozzles within soft drink machines. Soda Nozzle Cleaner is the first product specifically designed to address this issue. Approximately ¼ ounce of product powder is placed in one quart of warm water and soda nozzles and diffusers are soaked overnight, then rinsed with water and put back into soda soft-drink dispenser. The product is a cleaning powder composed of 20% Citric Acid, 11% Sodium Carbonate, 4.3% Pottassium Peroxymonosulfate, 1 0% SodiuPerborate Monohydrate, and 54.7% Non-Hazardous Ingredients.

### CLAIM

This product is the first of its kind to clean soda nozzles and diffusers that are part of a soda-soft drink dispenser. The powder removes sugar and soiled build up on the nozzles and diffusers without adverse effect to the rubber rings that are part of the nozzles. By adding the powder to water, then soaking the nozzles and diffusers in the substance overnight the product is able to perform the above task.

What is claimed is:

1. A Soda Nozzle Cleaner is a detergent capable of removing sugar and soil build up on nozzles and diffusers on fountain machine during the process of cleaning, comprising: (a) granules formed from a mixture of citric acid powder, sodium carbonate, potassium peroxymonosulfate, and sodium perborate monohydrate these particle size in a range from about 100 microns to about 1200 microns; said (b) the Soda Nozzle Cleaner product being adapted to readily dissolve and disperse the granules into one quart of water and soda nozzles and diffusers are soaked approximately eight to ten hours, then rinsed with water, and placed back into service on fountain machine.
